(19) United States
(12) Patent Application Publication
(10) Pub. No.: US 2026/0300318 A1
(43) Pub. Date: Oct. 1, 2026

(54) SEGMENT PARTITIONING FOR STORAGE SYSTEMS IMPLEMENTING A LOG-STRUCTURED MERGE ARCHITECTURE

(71) Applicant: Dell Products L.P., Round Rock, TX (US)

(72) Inventors: Vladimir Shveidel, Pardes-Hana (IL); Yosef Shatsky, Karnei Shomron (IL)

(21) Appl. No.: 19/091,029

(22) Filed: Mar. 26, 2025

(51) Int. Cl. G06F 16/27; G06F 16/22; G06F 16/2457

(52) U.S. Cl. CPC G06F 16/278; G06F 16/2246; G06F 16/24573

(57) ABSTRACT

An apparatus comprises at least one processing device configured to maintain, in memory, a log-structured merge data structure comprising metadata entries associated with input-output operations of a storage system, the log-structured merge data structure comprising multiple levels, a given one of the levels comprising a plurality of segments each partitioned into multiple subsegments. The at least one processing device is also configured to determine, responsive to detecting a merge condition, a merge set comprising at least two of the segments in the given level. The at least one processing device is further configured to merge metadata updates from the merge set to a core metadata store on a per-subsegment basis, and to remove the given subsegment of each of the segments in the merge set from the memory responsive to completing merge of the given subsegment to the core metadata store.

### BACKGROUND

Various types of storage systems, including storage systems implementing software-defined storage (SDS) solutions, may be configured to run workloads from multiple different end-users or applications. Different end-users or applications may have different performance and feature requirements for their associated workloads. In some workloads, performance may be most important. In other workloads, capacity utilization or other feature requirements may be most important. There is thus a need for techniques which enable a storage system to offer flexibility in storage offerings for workloads with different performance and feature requirements.

### SUMMARY

Illustrative embodiments of the present disclosure provide techniques for segment partitioning for storage system implementing a log-structured merge architecture.

In one embodiment, an apparatus comprises at least one processing device comprising a processor coupled to a memory. The at least one processing device is configured to maintain, in memory of a storage system, at least a portion of a log-structured merge data structure comprising metadata entries associated with input-output operations of the storage system, the log-structured merge data structure comprising two or more levels, a given one of the two or more levels comprising a plurality of segments each partitioned into two or more subsegments. The at least one processing device is also configured to determine, responsive to detecting a merge condition, a merge set comprising two or more of the plurality of segments in the given level of the log-structured merge data structure. The at least one processing device is further configured to merge metadata updates from the determined merge set to a core metadata store of the storage system on a per-subsegment basis and to remove a given one of the two or more subsegments of each of the two or more segments in the merge set from the memory of the storage system responsive to completing merge of the given subsegments to the core metadata store.

These and other illustrative embodiments include, without limitation, methods, apparatus, networks, systems and processor-readable storage media.

### BRIEF DESCRIPTION OF THE DRAWINGS

FIGS. 1A and 1B schematically illustrate an information processing system comprising a storage system configured for log-structured merge segment partitioning in an illustrative embodiment.

FIG. 2 is a flow diagram of an exemplary process for log-structured merge segment partitioning in an illustrative embodiment.

FIG. 3 shows a log-structured merge data structure in an illustrative embodiment.

FIG. 4 shows hash-based segment partitioning of a target segment in a log-structured merge data structure in an illustrative embodiment.

FIG. 5 shows merge-to-core processing for a log-structured merge data structure implementing segment partitioning in an illustrative embodiment.

FIG. 6 schematically illustrates a framework of a server node for implementing a storage node which hosts logic for segment partitioning for a log-structured merge data structure maintaining by a storage system in an illustrative embodiment.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

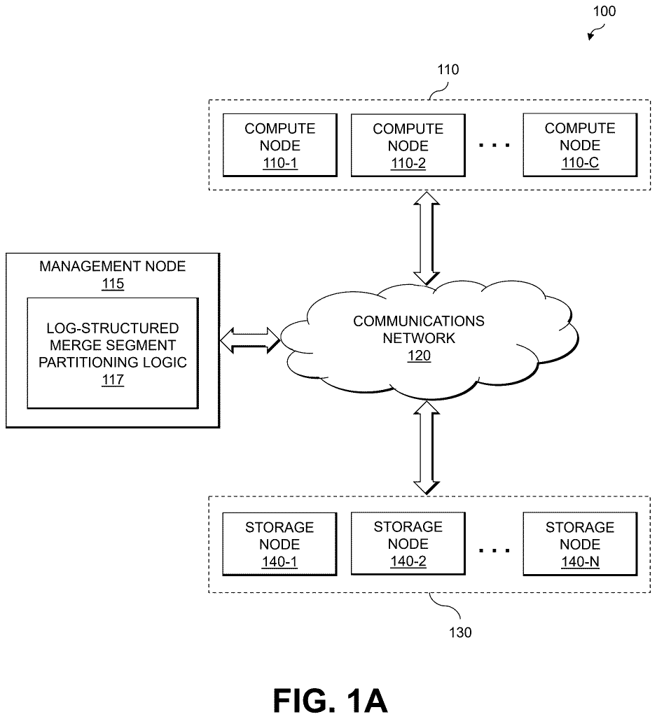

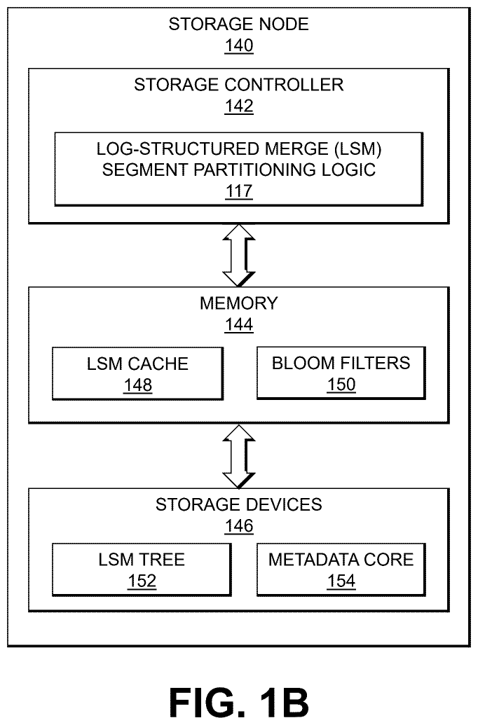

FIGS. 1A and 1B schematically illustrate an information processing system which is configured for segment partitioning for segments of a log-structured merge (LSM) data structure in a storage system implementing an LSM architecture according to an exemplary embodiment of the disclosure. More specifically, FIG. 1A schematically illustrates an information processing system 100 which comprises a plurality of compute nodes 110-1, 110-2, . . . , 110-C (collectively referred to as compute nodes 110, or each singularly referred to as a compute node 110), one or more management nodes 115 (which support a management layer of the system 100), a communications network 120, and a data storage system 130 (which supports a data storage layer of the system 100). The data storage system 130 comprises a plurality of storage nodes 140-1, 140-2, . . . , 140-N (collectively referred to as storage nodes 140, or each singularly referred to as a storage node 140). In the context of the exemplary embodiments described herein, the management nodes 115 and the data storage system 130 implement LSM segment partitioning logic 117 supporting optimization or improvement of IO processing in the data storage system 130. FIG. 1B schematically illustrates an exemplary framework of at least one or more of the storage nodes 140.

In particular, as shown in FIG. 1B, the storage node 140 comprises a storage controller 142, a memory 144 and a plurality of storage devices 146. In general, the storage controller 142 implements data storage and management methods that are configured to divide the storage capacity of the storage devices 146 into storage pools and logical volumes. Storage controller 142 is further configured to implement LSM segment partitioning logic 117 in accordance with the disclosed embodiments, as will be described in further detail below. It is to be noted that the storage controller 142 may include additional modules and other components typically found in conventional implementations of storage controllers and storage systems, although such additional modules and other components are omitted for clarity and simplicity of illustration.

The storage node 140 is assumed to implement an LSM storage architecture, in which the memory 144 includes an LSM cache 148 and a set of one or more bloom filters (BFs) 150. The LSM cache 148 provides an in-memory data structure with a limited size providing a buffer or cache for metadata for IO write operations. The LSM cache 148 has a limited size, and thus is not able to store the full LSM data structure. When the LSM cache 148 is full, data may be flushed to the storage devices 146 (e.g., using any desired cache replacement algorithm). The BFs 150 are space-efficient probabilistic data structures, which may be used to check if a given storage object is in the LSM cache 148. If a query to the BFs 150 returns a positive response, then the given storage object might be present in the LSM cache 148 (with some configurable false positive (FP) ratio). Thus, a search in the LSM cache 148 may be conducted for metadata associated with the given storage object. If the query to the BFs 150 returns a negative response, then the given storage object is definitely not in the LSM cache 148, and LSM tree 152 in the storage devices 146 may be searched directly for the given storage object (e.g., skipping a search of the LSM cache 148, providing efficiency for metadata reads). The LSM tree 152 is an example of what is more generally referred to herein as an “LSM data structure.” More generally, an LSM data structure may be any data structure or combination of data structures suitable for storing LSM-related information.

Data may also be periodically flushed from the LSM tree 152 to a metadata core 154 maintained in the storage devices 146. In some embodiments, the LSM cache 148 stores the entire LSM data structure, such that LSM tree 152 may be omitted (e.g., the entire LSM tree 152, rather than just the LSM cache 148, may be maintained in memory 144). The LSM segment partitioning logic 117 is configured to partition segments of an LSM data structure (e.g., LSM tree 152) into subsegments (e.g., utilizing hash-based partitioning). The LSM segment partitioning logic 117 is also configured to implement “merge-to-core” processing (e.g., flushing of a “merge set” including multiple segments of a bottom level of LSM tree 152 to the metadata core 154) on a per-subsegment basis, enabling faster and more efficient resource reclamation (e.g., of subsegments of the LSM tree 152, and ones of the BFs 150 associated with such subsegments) as the merge of each subsegment is completed.

In the embodiment of FIGS. 1A and 1B, the LSM segment partitioning logic 117 may be implemented at least in part within the one or more management nodes 115 as well as in one or more of the storage nodes 140 of the data storage system 130. This may include implementing different portions of the LSM segment partitioning logic 117 functionality described herein within the management nodes 115 and the storage nodes 140. In other embodiments, however, the LSM segment partitioning logic 117 may be implemented entirely within the management nodes 115 or entirely within the storage nodes 140. In still other embodiments, at least a portion of the functionality of the LSM segment partitioning logic 117 is implemented in one or more of the compute nodes 110.

The compute nodes 110 illustratively comprise physical compute nodes and/or virtual compute nodes which process data and execute workloads. For example, the compute nodes 110 can include one or more server nodes (e.g., bare metal server nodes) and/or one or more virtual machines. In some embodiments, the compute nodes 110 comprise a cluster of physical server nodes or other types of computers of an enterprise computer system, cloud-based computing system or other arrangement of multiple compute nodes associated with respective users. In some embodiments, the compute nodes 110 include a cluster of virtual machines that execute on one or more physical server nodes.

The compute nodes 110 are configured to process data and execute tasks/workloads and perform computational work, either individually, or in a distributed manner, to thereby provide compute services such as execution of one or more applications on behalf of each of one or more users associated with respective ones of the compute nodes. Such applications illustratively issue IO requests that are processed by a corresponding one of the storage nodes 140. The term “input-output” as used herein refers to at least one of input and output. For example, IO requests may comprise write requests and/or read requests directed to stored data of a given one of the storage nodes 140 of the data storage system 130.

The compute nodes 110 are configured to write data to and read data from the storage nodes 140 in accordance with applications executing on those compute nodes for system users. The compute nodes 110 communicate with the storage nodes 140 over the communications network 120. While the communications network 120 is generically depicted in FIG. 1A, it is to be understood that the communications network 120 may comprise any known communication network such as, a global computer network (e.g., the Internet), a wide area network (WAN), a local area network (LAN), an intranet, a satellite network, a telephone or cable network, a cellular network, a wireless network such as Wi-Fi or WiMAX, a storage fabric (e.g., Ethernet storage network), or various portions or combinations of these and other types of networks.

In this regard, the term “network” as used herein is therefore intended to be broadly construed so as to encompass a wide variety of different network arrangements, including combinations of multiple networks possibly of different types, which enable communication using, e.g., Transfer Control/Internet Protocol (TCP/IP) or other communication protocols such as Fibre Channel (FC), FC over Ethernet (FCOE), Internet Small Computer System Interface (iSCSI), Peripheral Component Interconnect express (PCIe), InfiniBand, Gigabit Ethernet, etc., to implement IO channels and support storage network connectivity. Numerous alternative networking arrangements are possible in a given embodiment, as will be appreciated by those skilled in the art.

The data storage system 130 may comprise any type of data storage system, or a combination of data storage systems, including, but not limited to, a storage area network (SAN) system, a network attached storage (NAS) system, a direct-attached storage (DAS) system, etc., as well as other types of data storage systems comprising software-defined storage, clustered or distributed virtual and/or physical infrastructure. The term “data storage system” as used herein should be broadly constructed and not viewed as being limited to storage systems of any particular type or types. In some embodiments, the storage nodes 140 comprise storage server nodes having one or more processing devices each having a processor and a memory, possibly implementing virtual machines and/or containers, although numerous other configurations are possible. In some embodiments, one or more of the storage nodes 140 can additionally implement functionality of a compute node, and vice-versa. The term “storage node” as used herein is therefore intended to be broadly construed, and a storage system in some embodiments can be implemented using a combination of storage nodes and compute nodes.

In some embodiments, as schematically illustrated in FIG. 1B, the storage node 140 is a physical server node or storage appliance, wherein the storage devices 146 comprise DAS resources (internal and/or external storage resources) such as hard-disk drives (HDDs), solid-state drives (SSDs), Flash memory cards, or other types of non-volatile memory (NVM) devices such non-volatile random-access memory (NVRAM), phase-change RAM (PC-RAM) and magnetic RAM (MRAM). These and various combinations of multiple different types of storage devices 146 may be implemented in the storage node 140. In this regard, the term “storage device” as used herein is intended to be broadly construed, so as to encompass, for example, SSDs, HDDs, flash drives, hybrid drives or other types of storage media. The storage devices 146 are connected to the storage node 140 through any suitable host interface, e.g., a host bus adapter, using suitable protocols such as ATA, SATA, eSATA, NVMe, NVMeOF, SCSI, SAS, etc. In other embodiments, the storage node 140 can be network connected to one or more NAS nodes over a local area network.

The storage controller 142 is configured to manage the storage devices 146 and control IO access to the storage devices 146 and/or other storage resources (e.g., DAS or NAS resources) that are directly attached or network-connected to the storage node 140. In some embodiments, the storage controller 142 is a component (e.g., storage data server) of a software-defined storage (SDS) system which supports the virtualization of the storage devices 146 by separating the control and management software from the hardware architecture. More specifically, in a software-defined storage environment, the storage controller 142 comprises an SDS storage data server that is configured to abstract storage access services from the underlying storage hardware to thereby control and manage IO requests issued by the compute nodes 110, as well as to support networking and connectivity. In this instance, the storage controller 142 comprises a software layer that is hosted by the storage node 140 and deployed in the data path between the compute nodes 110 and the storage devices 146 of the storage node 140, and is configured to respond to data IO requests from the compute nodes 110 by accessing the storage devices 146 to store/retrieve data to/from the storage devices 146 based on the IO requests.

In a software-defined storage environment, the storage controller 142 is configured to provision, orchestrate and manage the local storage resources (e.g., the storage devices 146) of the storage node 140. For example, the storage controller 142 implements methods that are configured to create and manage storage pools (e.g., virtual pools of block storage) by aggregating capacity from the storage devices 146. The storage controller 142 can divide a storage pool into one or more volumes and expose the volumes to the compute nodes 110 as virtual block devices. For example, a virtual block device can correspond to a volume of a storage pool. Each virtual block device comprises any number of actual physical storage devices, wherein each block device is preferably homogenous in terms of the type of storage devices that make up the block device (e.g., a block device only includes either HDD devices or SSD devices, etc.).

In the software-defined storage environment, each of the storage nodes 140 in FIG. 1A can run an instance of the storage controller 142 to convert the respective local storage resources (e.g., DAS storage devices and/or NAS storage devices) of the storage nodes 140 into local block storage. Each instance of the storage controller 142 contributes some or all of its local block storage (HDDs, SSDs, PCIe, NVMe and flash cards) to an aggregated pool of storage of a storage server node cluster (e.g., cluster of storage nodes 140) to implement a server-based storage area network (SAN) (e.g., virtual SAN). In this configuration, each storage node 140 is part of a loosely coupled server cluster which enables “scale-out” of the software-defined storage environment, wherein each instance of the storage controller 142 that runs on a respective one of the storage nodes 140 contributes its local storage space to an aggregated virtual pool of block storage with varying performance tiers (e.g., HDD, SSD, etc.) within a virtual SAN.

In some embodiments, in addition to the storage controllers 142 operating as SDS storage data servers to create and expose volumes of a storage layer, the software-defined storage environment comprises other components such as (i) SDS data clients that consume the storage layer and (ii) SDS metadata managers that coordinate the storage layer, which are not specifically shown in FIG. 1A. More specifically, on the client-side (e.g., compute nodes 110), an SDS data client (SDC) is a lightweight block device driver that is deployed on each server node that consumes the shared block storage volumes exposed by the storage controllers 142. In particular, the SDCs run on the same servers as the compute nodes 110 which require access to the block devices that are exposed and managed by the storage controllers 142 of the storage nodes 140. The SDC exposes block devices representing the virtual storage volumes that are currently mapped to that host. In particular, the SDC serves as a block driver for a client (server), wherein the SDC intercepts IO requests, and utilizes the intercepted IO request to access the block storage that is managed by the storage controllers 142. The SDC provides the operating system or hypervisor (which runs the SDC) access to the logical block devices (e.g., volumes).

The SDCs have knowledge of which SDS control systems (e.g., storage controller 142) hold its block data, so multipathing can be accomplished natively through the SDCs. In particular, each SDC knows how to direct an IO request to the relevant destination SDS storage data server (e.g., storage controller 142). In this regard, there is no central point of routing, and each SDC performs its own routing independent from any other SDC. This implementation prevents unnecessary network traffic and redundant SDS resource usage. Each SDC maintains peer-to-peer connections to every storage controller 142 that manages the storage pool. A given SDC can communicate over multiple pathways to all of the storage nodes 140 which store data that is associated with a given IO request. This multi-point peer-to-peer fashion allows the SDS to read and write data to and from all points simultaneously, eliminating bottlenecks and quickly routing around failed paths.

The management nodes 115 in FIG. 1A implement a management layer that is configured to manage and configure the storage environment of the system 100. In some embodiments, the management nodes 115 comprise the SDS metadata manager components, wherein the management nodes 115 comprise a tightly-coupled cluster of nodes that are configured to supervise the operations of the storage cluster and manage storage cluster configurations. The SDS metadata managers operate outside of the data path and provide the relevant information to the SDS clients and storage servers to allow such components to control data path operations. The SDS metadata managers are configured to manage the mapping of SDC data clients to the SDS data storage servers. The SDS metadata managers manage various types of metadata that are required for system operation of the SDS environment such as configuration changes, managing the SDS data clients and data servers, device mapping, values, snapshots, system capacity including device allocations and/or release of capacity, RAID protection, recovery from errors and failures, and system rebuild tasks including rebalancing.

While FIG. 1A shows an exemplary embodiment of a two-layer deployment in which the compute nodes 110 are separate from the storage nodes 140 and connected by the communications network 120, in other embodiments, a converged infrastructure (e.g., hyperconverged infrastructure) can be implemented to consolidate the compute nodes 110, storage nodes 140, and communications network 120 together in an engineered system. For example, in a hyperconverged deployment, a single-layer deployment is implemented in which the storage data clients and storage data servers run on the same nodes (e.g., each node deploys a storage data client and storage data servers) such that each node is a data storage consumer and a data storage supplier. In other embodiments, the system of FIG. 1A can be implemented with a combination of a single-layer and two-layer deployment.

Regardless of the specific implementation of the storage environment, as noted above, various modules of the storage controller 142 of FIG. 1B collectively provide data storage and management methods that are configured to perform various functions as follows. In particular, a storage virtualization and management services module may implement any suitable logical volume management (LVM) system which is configured to create and manage local storage volumes by aggregating the local storage devices 146 into one or more virtual storage pools that are thin-provisioned for maximum capacity, and logically dividing each storage pool into one or more storage volumes that are exposed as block devices (e.g., raw logical unit numbers (LUNs)) to the compute nodes 110 to store data. In some embodiments, the storage devices 146 are configured as block storage devices where raw volumes of storage are created and each block can be controlled as, e.g., an individual disk drive by the storage controller 142. Each block can be individually formatted with a same or different file system as required for the given data storage system application.

In some embodiments, the storage pools are primarily utilized to group storage devices based on device types and performance. For example, SSDs are grouped into SSD pools, and HDDs are grouped into HDD pools. Furthermore, in some embodiments, the storage virtualization and management services module implements methods to support various data storage management services such as data protection, data migration, data deduplication, replication, thin provisioning, snapshots, data backups, etc.

Storage systems, such as the data storage system 130 of system 100, may be required to provide both high performance and a rich set of advanced data service features for end-users thereof (e.g., users operating compute nodes 110, applications running on compute nodes 110). Performance may refer to latency, or other metrics such as IO operations per second (IOPS), bandwidth, etc. Advanced data service features may refer to data service features of storage systems including, but not limited to, services for data resiliency, thin provisioning, data reduction, space efficient snapshots, etc. Fulfilling both performance and advanced data service feature requirements can represent a significant design challenge for storage systems. This may be due to different advanced data service features consuming significant resources and processing time. Such challenges may be even greater in software-defined storage systems in which custom hardware is not available for boosting performance.

Device tiering may be used in some storage systems, such as in storage systems that contain some relatively “fast” and expensive storage devices and some relatively “slow” and less expensive storage devices. In device tiering, the “fast” devices may be used when performance is the primary requirement, where the “slow” and less expensive devices may be used when capacity is the primary requirement. Such device tiering may also use cloud storage as the “slow” device tier. Some storage systems may also or alternately separate devices offering the same performance level to gain performance isolation between different sets of storage volumes. For example, the storage systems may separate the “fast” devices into different groups to gain performance isolation between storage volumes on such different groups of the “fast” devices.

Illustrative embodiments provide functionality for optimizing or improving performance of storage systems which utilize LSM-based storage architectures (e.g., for LSM-based metadata updates), though partitioning of segments of an LSM data structure, and for implementing merge-to-core processing (e.g., merging of segments of the LSM data structure to a core metadata store) on a per-subsegment basis enabling more efficient release or reclamation of resources as the merge-to-core processing is being performed. The LSM segment partitioning logic 117 is configured to partition segments in one or more levels of an LSM data structure (e.g., LSM tree 152) into subsegments, where at least a portion of the LSM data structure is maintained in memory 144 (e.g., in the LSM cache 148). The LSM segment partitioning logic 117 further maintains subsegment-specific BFs 150. The LSM segment partitioning logic 117 is also configured to perform merge-to-core processing for moving a “merge set” including multiple segments (e.g., in a bottom level of the LSM tree 152) to the metadata core 154, where the merge-to-core processing is done on a per-subsegment basis such that subsegments with the same index in each of the segments of the merge set are merged to the metadata core 154, after which resources for that subsegment may be released or reclaimed (e.g., removing that subsegment of each of the segments of the merge set from the LSM cache 148 and LSM tree 152, and removing ones of the BFs 150 specific to that subsegment for each of the segments of the merge set) immediately, without waiting for the entirety of the merge-to-core processing to complete.

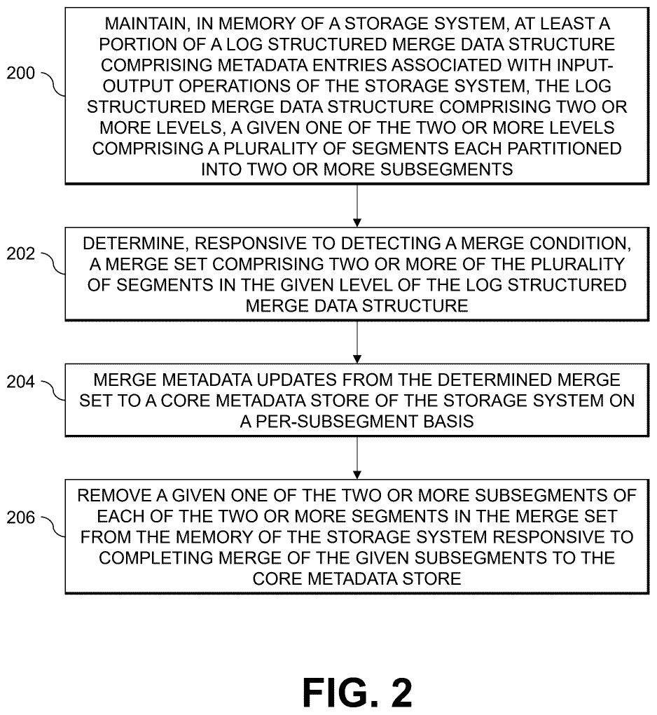

An exemplary process for segment partitioning for a storage system implementing an LSM architecture will now be described in more detail with reference to the flow diagram of FIG. 2. It is to be understood that this particular process is only an example, and that additional or alternative processes for segment partitioning for storage systems implementing an LSM architecture may be used in other embodiments.

In this embodiment, the process includes steps 200 through 206. These steps are assumed to be performed using the LSM segment partitioning logic 117, which as noted above may be implemented in the management nodes 115 of system 100, in storage nodes 140 of the data storage system 130 of system 100, in compute nodes 110 of system 100, combinations thereof, etc. The process begins with step 200, maintaining, in memory of a storage system, at least a portion of an LSM data structure comprising metadata entries associated with IO operations of the storage system. The LSM data structure comprises two or more levels, a given one of the two or more levels comprising a plurality of segments each partitioned into two or more subsegments.

The plurality of segments may comprise time-ordered metadata entries associated with the IO operations of the storage system. The plurality of segments in the given level of the LSM data structure may be partitioned into the two or more subsegments utilizing hash-based partitioning. The hash-based partitioning may be based at least in part on utilizing a hash function of one or more most significant bits of keys of the metadata entries associated with the IO operations of the storage system. The hash function may distribute the metadata entries associated with the IO operations substantially (e.g., statistically, based on the hash algorithm of the hash function) equally among the two or more subsegments.

In step 202, responsive to detecting a merge condition, a merge set is determined, the merge set comprising two or more of the plurality of segments in the given level of the LSM data structure. The merge set may comprise less than all of the plurality of segments in the given level of the LSM data structure.

Metadata updates from the determined merge set are merged to a core metadata store of the storage system on a per-subsegment basis in step 204. Each of the two or more subsegments may comprise metadata entries associated with a set of sub-trees of a tree structure maintained in the core metadata store. The tree structure maintained in the core metadata store may comprise a B-tree. Step 204 may be performed in a set of cycles, each cycle comprising merging of metadata updates associated with a specific subsegment index associated with one of the two or more subsegments in each of the two or more segments in the merge set. Step 204 may include merging metadata updates from a first one of the two or more subsegments in each of the two or more segments in the merge set utilizing a first worker thread that operates at least in part in parallel with merging metadata updates from a second one of the two or more subsegments in each of the two or more segments in the merge set utilizing a second worker thread.

In step 206, a given one of the two or more subsegments of each of the two or more segments in the merge set is removed from the memory of the storage system responsive to completing merge of the given subsegment to the core metadata store. Step 206 may comprise removing the given subsegment of each of the two or more segments in the merge set from the memory of the storage system prior to completing merge of all of the merge set to the core metadata store of the storage system.

In some embodiments, step 200 also includes maintaining, in the memory of the storage system, a plurality of BFs, where each of the two or more subsegments is associated with a subsegment-specific one of the plurality of BFs. In such embodiments, step 206 may further include, removing a given subsegment-specific one of the plurality of bloom filters associated with the given subsegment responsive to completing merge of the given subsegment to the core metadata store.

The FIG. 2 process may further include receiving a query directed to one of the plurality of segments of the given level of the LSM data structure that is partitioned into the two or more subsegments, identifying a target one of the two or more subsegments for the received query based at least in part on computing a hash of a key in the received query, and perform the query against the target one of the two or more subsegments.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Storage clusters and other storage systems may apply LSM techniques to optimize metadata (MD) update flows. In such systems, MD updates (e.g., MD deltas) are collected or aggregated in time-ordered contiguous LSM chunks or segments, that are periodically merged or compacted to larger chunks or segments in a next or bottom level of the LSM data structure (e.g., an LSM tree may include 2-5 levels). Merges from the bottom level of the LSM are done to a core MD store. This allows for reducing MD “write amplification” by avoiding or minimizing random small updates of core MD pages. Many deltas are aggregated inside the LSM data structure, and are applied to the MD core together in a single write operation in an aggregated manner.

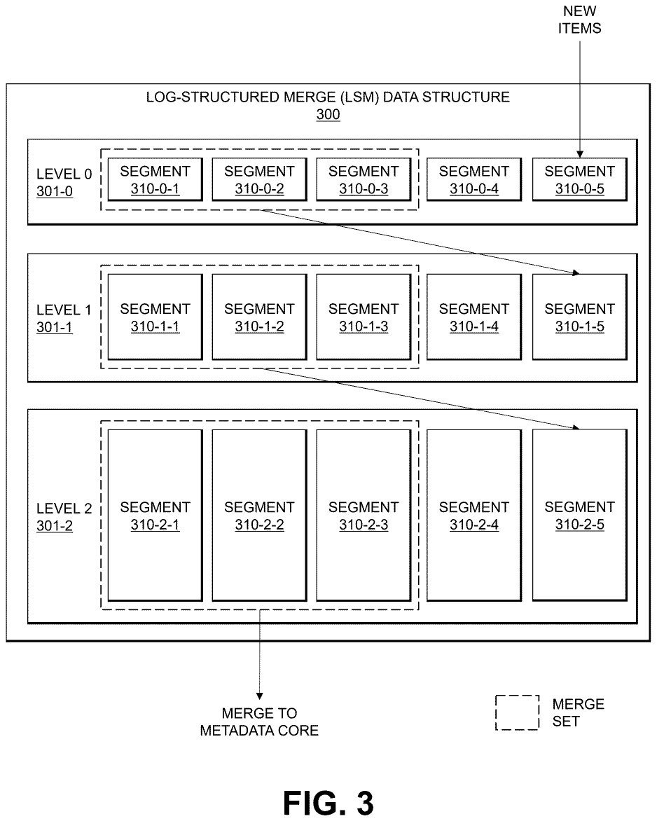

FIG. 3 shows an LSM data structure 300 including three levels-level 301-0, level 301-1 and level 301-2 (collectively, levels 301). Each of the levels 301 includes a set of segments. Level 301-0 includes segments 310-0-1, 310-0-2, 310-0-3, 310-0-4 and 310-0-5 (collectively, segments 310-0). Level 301-1 includes segments 310-1-1, 310-1-2, 310-1-3, 310-1-4 and 310-1-5 (collectively, segments 310-1). Level 301-2 includes segments 310-2-1, 310-2-2, 310-2-3, 310-2-4 and 310-2-5 (collectively, segments 310-2). New items are written to segment 310-0-5 in level 301-0. When enough items are accumulated in level 301-0, a merge set including segments 310-0-1, 310-0-2 and 310-0-3 are merged to segment 310-1-5 in level 301-1. When enough items are accumulated in level 301-1, a merge set including segments 310-1-1, 310-1-2 and 310-1-3 are merged to segment 310-2-5 in level 301-2. When enough items are accumulated in level 301-2, a merge set including segments 310-2-1, 310-2-2 and 310-2-3 are merged to a MD core.

As illustrated in FIG. 3, the LSM data structure 300 is composed of multiple levels 301, where each of the levels 301 contains multiple segments. Each segment contains ordered items (e.g., MD deltas). Multiple segments from a level i are merged into a single segment that is then placed in level i+1. The number of segments to merge is implementation-specific. In the FIG. 3 example, segments are merged in sets of 3. The group of segments which are merged together is called a merge set. The “height” of each of the segments in FIG. 3 indicates the relative size of the segments (e.g., segments 310-0 are smaller than segments 310-1, and segments 310-1 are smaller than segments 310-2). To allow for fast lookup of items in the LSM data structure 300, each segment may be associated with a BF. When segments are merged, a new BF is created for the new segment. It should be appreciated that once a merge set is merged (e.g., from one of the levels 301 to another, or from level 301-2 to the MD core), the source segments are removed from the LSM data structure 300 and their associated BFs are also removed.

The LSM data structure 300 accumulates changes which are fed to a larger “core” structure (e.g., MD core) that is not write optimized (e.g., a B-tree) and which contains the vast majority of the items. The LSM data structure 300 behaves as a type of journal to the larger MD core structure, accumulating changes to be applied to the MD core in bulk. The advantage of this is write amortization (e.g., a page in the MD core is written to serve many items in the LSM instead of only one). This considerably reduces the write overhead required for MD updates. The larger the LSM data structure 300 is (e.g., the more deltas or items which are collected therein), the better the write amortization and aggregation to the MD core will be. From the other side, any read operation that requires a MD page should potentially search in all chunks or segments of the LSM data structure, since any of them may potentially contain the relevant MD, and not just in the core MD pages. To reduce the number of LSM read operations, in-memory BFs may be maintained for all LSM segments. Each MD update (e.g., key) that is added to a segment is also added to the corresponding BF. Thus, before reading or searching for a key in an LSM segment, the key is looked-up in the corresponding volatile BF. If the lookup succeeds, the corresponding segment is read.

To provide good MD update write amortization, the size of the LSM data structure 300 (specifically, the size of the bottom level 301-2 thereof where merges to the MD core are performed from) should be rather large (e.g., 0.5-5% of the entire size of the MD core). Merging of the MD from the LSM data structure 300 to the MD core is a processor-intensive (e.g., central processing unit (CPU)-intensive) job, and can take a long time (e.g., tens of minutes in a loaded storage system). The merge to MD core job thus suffers from various technical challenges, including a very strong overuse of resources (e.g., random-access memory (RAM) for BFs) and non-smooth merge-to-core processing. Illustrative embodiments provide technical solutions for implementing an LSM data structure with hash-based segment partitioning to address these and other technical challenges, by providing gradual resource (e.g., RAM) reclamation as the merge-to-core processing job progresses. This advantageously allows for smoother merge-to-core processing with zero or minimal resource overhead and enables supporting more capacity on the same hardware.

To provide good MD update write amortization, the LSM size (specifically, a size of the bottom level of the LSM data structure where merges to the MD core are performed from) should be rather large (e.g., 0.5-5% of the entire size of the MD core). For example, a capacity-utilized storage cluster may include an LSM data structure with a bottom level having a merge set including 8 segments, where each segment has a size of 16,384* 4 kilobytes (KB). This is a large amount of MD, and it also requires significant resources (e.g., RAM for BFs) to maintain it. Merging of such a large amount of MD from the LSM data structure to the MD core is a large CPU job which takes significant time (e.g., tens of minutes in a loaded storage system). This large merge-to-core job presents various technical challenges related to overuse of resources and non-smooth merge-to-core processing. Overuse of resources includes overprovisioning or overutilization of RAM for BFs, as the BFs of all segments in the merge set (e.g., 8 segments in this example) cannot be reclaimed until the merge-to-core is completed. At the same time, new segments (e.g., 8 segments in this example) are collected during the merge-to-core process. Thus, at the merge-to-core completion moment, the system maintains up to 16 active segments and 16 segment BFs (e.g., 2× overhead). Assuming memory for BFs is one of the main RAM contributors, this overhead may reach tens of gigabytes (GBs). Further, there is motivation to complete the merge-to-core processing as soon as possible (e.g., before another merge set is ready to merge) to minimize memory overhead. The technical solutions described herein provide approaches for implementing an LSM data structure with hash-based segment partitioning, which address these and other technical challenges by providing gradual resource (e.g., RAM) reclamation as the merge-to-core job progresses. This advantageously allows smoother merge-to-core processing with zero or minimal resource overhead, and also enables supporting more capacity with the same hardware resources.

An LSM data structure with hash-based segment partitioning creates segments in a bottom level of the LSM data structure as sets or arrays of subsegments. A target subsegment (e.g., an index within an array of subsegments) for any specific entry is defined as a hash function of a designated number of the Most Significant Bits (MSBs) of the entry's key. Thus, all neighbor entries will be in the same subsegment (e.g., as their MSBs are the same). Each subsegment therefore contains updates related to some specific area (e.g., a sub-tree) of a MD core. Further, subsegments will have an equal population/size statistically (e.g., as a result of hash randomization). The size of the array (e.g., the number of subsegments in the array) is a power of two in the range of 32-1024 for segments of 16,384 pages. The exact size of the array may be a tunable parameter. Each subsegment has its own (e.g., allocated separately) BF. The merge-to-core processing is executed subsegment by subsegment (e.g., subsegments with the same index in all segments in the merge set are merged to the MD core together). Once the merge of a particular subsegment index is completed, resources (e.g., the BF) associated with the subsegment for that index in all segments in the merge set are reclaimed. Therefore, resource reclamation is gradual as the merge-to-core job progresses. Further, this mechanism allows for merging several subsegments concurrently enabling a very high merge-to-core processing rate.

The partitioned segment layout for an LSM data structure will now be described. A general assumption is that all subsegments will have approximately equal size (e.g., the subsegment size is the segment size divided by the number of subsegments, plus a designated overprovisioning factor). Statistically, the subsegments population will be equal (e.g., as a result of hashing), and 5-10% of overprovisioning will be enough to accommodate random fluctuations in the vast majority of cases. Nevertheless, in some rare cases fluctuation may be such that even an overprovisioned segment cannot accommodate required content. Thus, a subsegment extension mechanism may be used in some embodiments. If a subsegment has an extension, the corresponding reference/pointer is added to metadata or a header of this subsegment. The extension itself may be located out of the subsegment array.

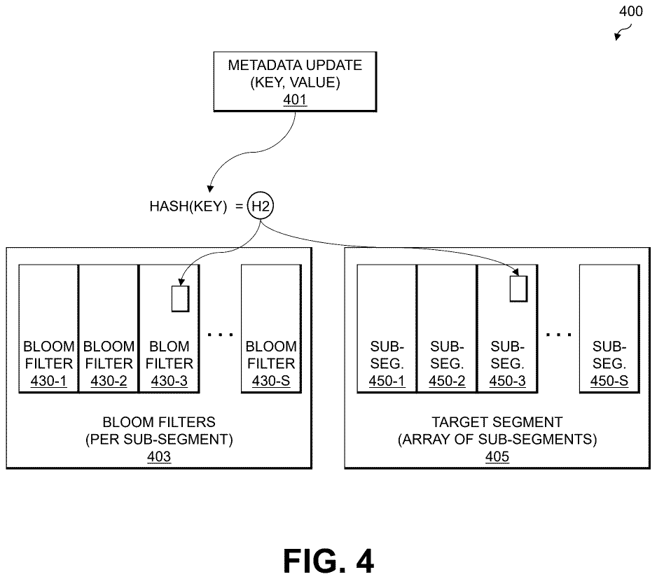

A process flow for building partitioned segments of an LSM data structure will now be described with respect to FIG. 4, which shows a partitioned segment layout 400 and logic for routing a metadata update 401 (e.g., a key, value for a merged entry) to a target subsegment within a target segment 405 comprising an array of subsegments. The target segment 405 includes a plurality of subsegments 450-1, 450-2, 450-3, . . . 450-S (collectively, subsegments 450). Each of the subsegments 450 contains a set of sub-trees of a main tree structure maintained in the MD core. Since the target subsegment is defined as hash(ke), keys from very different parts of the tree structure in the MD core (e.g., from different subtrees) are maintained in the same subsegment. Additionally, as the hash is calculated not from the key itself but from the MSB of the key, this means that all keys with the same MSB will have the same hash and will be located in the same subsegment. Therefore, small subtrees containing keys with the same MSBs, but possibly different least significant bits (LSBs), are distributed between the subsegments 450. Thus, each of the subsegments 450 may include a tree structure that includes many small subtrees taken from different, well-distributed areas of the tree structure maintained in the MD core.

A set of BFs 403 is also maintained (e.g., one BF for each subsegment), including BFs 430-1, 430-2, 430-3, . . . 430-S (collectively, BFs 430). These subsegment specific BFs 430 may also be referred to herein as sub-BFs 430. The process for merging to partitioned segments includes inserting the “merged” entry to the right subsegment within the target segment 405 according to hash(key) logic, where the key of the metadata update 401 is hashed to return a value, which determines the specific one of the subsegments 450 (in the FIG. 4 example, subsegment 450-3) to insert the metadata update 401. Once the metadata update 401 is added to the subsegment 450-3, the key is also inserted into the BF specific to that subsegment (e.g., the BF 430-3 in the FIG. 4 example) with the same index in the array.

Various strategies may be used to implement the merging algorithm. In some embodiments, a target segment in an LSM data structure is built subsegment by subsegment. In this case, source segment trees are scanned area by area to find entries related to the currently built subsegment (e.g., with the required hash(key)) in all segments of the merge set. Since the hash function is calculated from the MSBs of the key, the required entries are localized in some area of the source segment trees. In other embodiments, all subsegments of a target segment are built concurrently. In this case, each merged entry is put into the target subsegment without taking care that all processed entries should related just to one specific subsegment. This algorithm is simpler computation-wise, but it requires more resources (e.g., since the entire set of subsegments, instead of just one, is “in progress”). Thus, this algorithm may be applied as a temporary simplified solution.

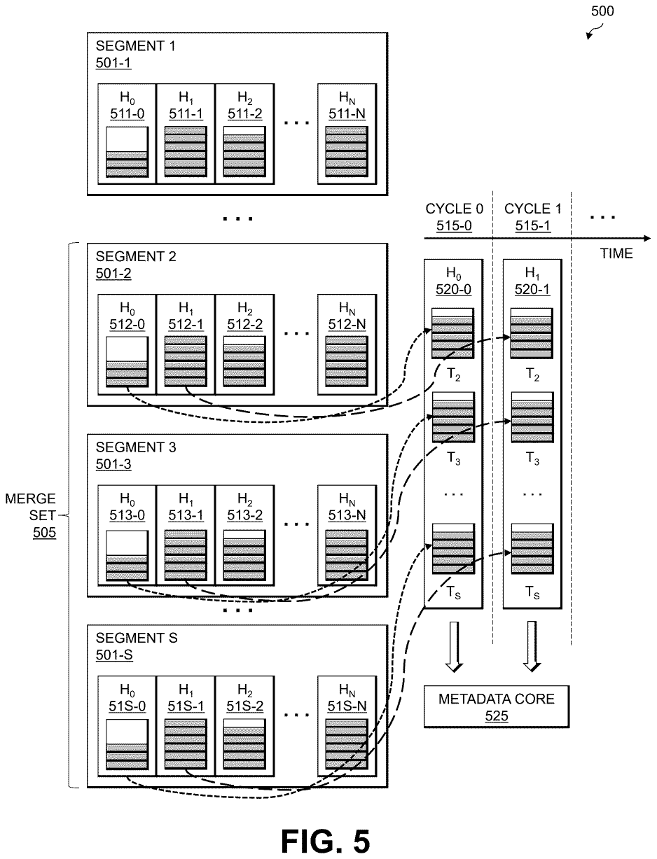

The merge-to-core processing flow is performed subsegment by subsegment, as illustrated by FIG. 5. In the system 500 of FIG. 5, there is a set of segments 501-1, 501-2, 501-3, . . . 501-S (collectively, segments 501), of which segments 501-2 through 501-S are part of a merge set. Each of the segments 501 includes a respective set of subsegments. Segment 501-1 includes subsegments 511-0, 511-1, 511-2, . . . 511-N (collectively, subsegments 511), segment 501-2 includes subsegments 512-0, 512-1, 512-2, . . . 512-N (collectively, subsegments 512), segment 501-3 includes subsegments 513-0, 513-1, 513-2, . . . 513-N (collectively, subsegments 513) and segment 501-S includes subsegments 51S-0, 51S-1, 51S-2, . . . 51S-N (collectively, subsegments 51S). The merge-to-core processing flow is performed subsegment by subsegment in a sequence of cycles 515-0, 515-1, etc. (collectively, cycles 515), where respective subsegment indexes 520-0, 520-1, etc. are merged to MD core 525. The cycle 515-0 for subsegment index 520-0 is associated with subsegments having hash index Ho (e.g., subsegments 511-0, 512-0, 513-0, . . . 51S-0), the cycle 515-1 for subsegment index 520-1 is associated with subsegments having hash index H1 (e.g., subsegments 511-1, 512-1, 513-1, . . . 51S-1), etc.

A “vertical column” of subsegments refer to those subsegments with the same index (e.g., Ho, H1, H2, . . . HN) in all segments included in the merge set 505, and provides a “sub-merge-set” for each of the merge cycles 515. Subsegment tree structures (denoted T2 for segment 501-2, T3 for segment 501-3, . . . Ts for segment 501-S in the merge set 505) are merged with any suitable merging algorithm. The vertical columns are the “atom” of the merge-to-core processing flow. The merge of each vertical column is an independent flow that may be implemented by a separate worker thread. Subsegments (e.g., “vertical columns”) may be merged either one-by-one, or several vertical columns may be merged concurrently (e.g., several concurrent workers are enforced in this case). Such concurrent merge processing allows for very high bandwidth of the merge-to-core, from one side. From the other side, it involves extra complexity and extra logic to synchronize and coordinate concurrent updates to the same MD core tree. When managed well, no or minimal coordination may be really required, since updates are done to different areas (e.g., sub-trees) of the overall tree. In some strategies for choosing subsegments for concurrent merge processing, some coordination is required. Once merging of a subsegment (e.g., a “vertical column” in FIG. 5) is completed, all resources associated with that subsegment in each of the segments 501-2 through 501-S that are part of the merge set 505 (e.g., BFs for such subsegments, also referred to herein as sub-BFs) may be reclaimed immediately. Therefore, memory is reclaimed gradually as the merge-to-core processing flow progresses, providing allocatable space for new LSM segments that are being built concurrently. In an ideal case, the merge-to-core process flow should follow (e.g., be the same as) the new ingest rate to the bottom level of the LSM data structure, which provides completely smooth merge-to-core processing, where resources required for such processing correspond to the resources required for just one merge set (e.g., 8 segments in some examples) with minimal or zero overhead.

Querying of an LSM data structure implementing hash-based partitioning of segments into subsegments utilizes specialized processing for search and access to partitioned segments (e.g., segments in the bottom level of the LSM data structure). When querying a partitioned segment, the hash of the key is first calculated. The hash is used as an index inside an array of sub-BFs as well as the array of subsegments, to locate the target sub-BF and target subsegment. Once the target sub-BF and the target subsegment are located, the query is performed against those structures.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

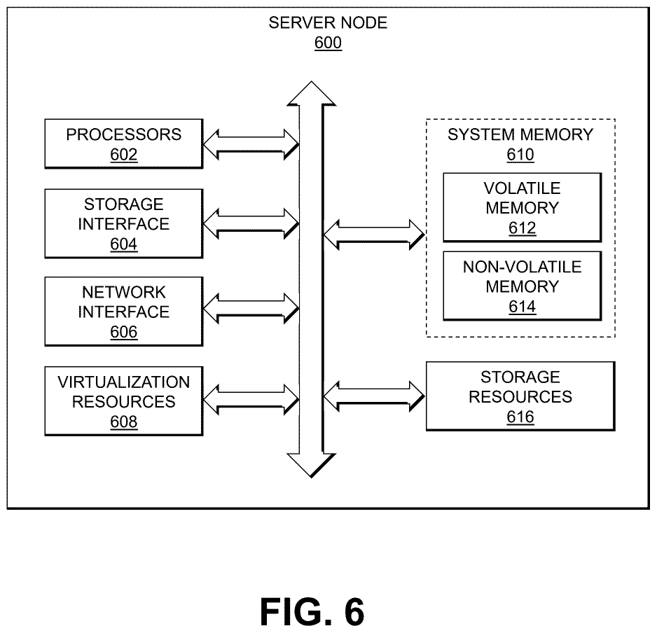

FIG. 6 schematically illustrates a framework of a server node (or more generally, a computing node) for hosting logic for segment partitioning for an LSM data structure according to an exemplary embodiment of the disclosure. The server node 600 comprises processors 602, storage interface circuitry 604, network interface circuitry 606, virtualization resources 608, system memory 610, and storage resources 616. The system memory 610 comprises volatile memory 612 and non-volatile memory 614. The processors 602 comprise one or more types of hardware processors that are configured to process program instructions and data to execute a native operating system (OS) and applications that run on the server node 600.

For example, the processors 602 may comprise one or more CPUs, microprocessors, microcontrollers, application specific integrated circuits (ASICs), field programmable gate arrays (FPGAs), and other types of processors, as well as portions or combinations of such processors. The term “processor” as used herein is intended to be broadly construed so as to include any type of processor that performs processing functions based on software, hardware, firmware, etc. For example, a “processor” is broadly construed so as to encompass all types of hardware processors including, for example, (i) general purpose processors which comprise “performance cores” (e.g., low latency cores), and (ii) workload-optimized processors, which comprise any possible combination of multiple “throughput cores” and/or multiple hardware-based accelerators. Examples of workload-optimized processors include, for example, graphics processing units (GPUs), digital signal processors (DSPs), system-on-chip (SoC), tensor processing units (TPUs), image processing units (IPUs), deep learning accelerators (DLAs), artificial intelligence (AI) accelerators, and other types of specialized processors or coprocessors that are configured to execute one or more fixed functions.

The storage interface circuitry 604 enables the processors 602 to interface and communicate with the system memory 610, the storage resources 616, and other local storage and off-infrastructure storage media, using one or more standard communication and/or storage control protocols to read data from or write data to volatile and non-volatile memory/storage devices. Such protocols include, but are not limited to, non-volatile memory express (NVMe), peripheral component interconnect express (PCIe), Parallel ATA (PATA), Serial ATA (SATA), Serial Attached SCSI (SAS), Fibre Channel, etc. The network interface circuitry 606 enables the server node 600 to interface and communicate with a network and other system components. The network interface circuitry 606 comprises network controllers such as network cards and resources (e.g., network interface controllers (NICs) (e.g., SmartNICs, RDMA-enabled NICs), Host Bus Adapter (HBA) cards, Host Channel Adapter (HCA) cards, I/O adaptors, converged Ethernet adaptors, etc.) to support communication protocols and interfaces including, but not limited to, PCIe, DMA and RDMA data transfer protocols, etc.

The virtualization resources 608 can be instantiated to execute one or more services or functions which are hosted by the server node 600. For example, the virtualization resources 608 can be configured to implement the various modules and functionalities as discussed herein. In one embodiment, the virtualization resources 608 comprise virtual machines that are implemented using a hypervisor platform which executes on the server node 600, wherein one or more virtual machines can be instantiated to execute functions of the server node 600. As is known in the art, virtual machines are logical processing elements that may be instantiated on one or more physical processing elements (e.g., servers, computers, or other processing devices). That is, a “virtual machine” generally refers to a software implementation of a machine (i.e., a computer) that executes programs in a manner similar to that of a physical machine. Thus, different virtual machines can run different operating systems and multiple applications on the same physical computer.

A hypervisor is an example of what is more generally referred to as “virtualization infrastructure.” The hypervisor runs on physical infrastructure, e.g., CPUs and/or storage devices, of the server node 600, and emulates the CPUs, memory, hard disk, network and other hardware resources of the host system, enabling multiple virtual machines to share the resources. The hypervisor can emulate multiple virtual hardware platforms that are isolated from each other, allowing virtual machines to run, e.g., Linux and Windows Server operating systems on the same underlying physical host. The underlying physical infrastructure may comprise one or more commercially available distributed processing platforms which are suitable for the target application.

In another embodiment, the virtualization resources 608 comprise containers such as Docker containers or other types of Linux containers (LXCs). As is known in the art, in a container-based application framework, each application container comprises a separate application and associated dependencies and other components to provide a complete filesystem, but shares the kernel functions of a host operating system with the other application containers. Each application container executes as an isolated process in user space of a host operating system. In particular, a container system utilizes an underlying operating system that provides the basic services to all containerized applications using virtual-memory support for isolation. One or more containers can be instantiated to execute one or more applications or functions of the server node 600 as well execute one or more of the various modules and functionalities as discussed herein. In yet another embodiment, containers may be used in combination with other virtualization infrastructure such as virtual machines implemented using a hypervisor, wherein Docker containers or other types of LXCs are configured to run on virtual machines in a multi-tenant environment.

The various components of, e.g., the LSM segment partitioning logic 117, comprise program code that is loaded into the system memory 610 (e.g., volatile memory 612), and executed by the processors 602 to perform respective functions as described herein. In this regard, the system memory 610, the storage resources 616, and other memory or storage resources as described herein, which have program code and data tangibly embodied thereon, are examples of what is more generally referred to herein as “processor-readable storage media” that store executable program code of one or more software programs. Articles of manufacture comprising such processor-readable storage media are considered embodiments of the disclosure. An article of manufacture may comprise, for example, a storage device such as a storage disk, a storage array or an integrated circuit containing memory. The term “article of manufacture” as used herein should be understood to exclude transitory, propagating signals.

The system memory 610 comprises various types of memory such as volatile RAM, NVRAM, or other types of memory, in any combination. The volatile memory 612 may be a dynamic random-access memory (DRAM) (e.g., DRAM DIMM (Dual In-line Memory Module), or other forms of volatile RAM. The non-volatile memory 614 may comprise one or more of NAND Flash storage devices, SSD devices, or other types of next generation non-volatile memory (NGNVM) devices. The system memory 610 can be implemented using a hierarchical memory tier structure wherein the volatile memory 612 is configured as the highest-level memory tier, and the non-volatile memory 614 (and other additional non-volatile memory devices which comprise storage-class memory) is configured as a lower level memory tier which is utilized as a high-speed load/store non-volatile memory device on a processor memory bus (i.e., data is accessed with loads and stores, instead of with I/O reads and writes). The term “memory” or “system memory” as used herein refers to volatile and/or non-volatile memory which is utilized to store application program instructions that are read and processed by the processors 602 to execute a native operating system and one or more applications or processes hosted by the server node 600, and to temporarily store data that is utilized and/or generated by the native OS and application programs and processes running on the server node 600. The storage resources 616 can include one or more HDDs, SSD storage devices, etc.

It is to be understood that the above-described embodiments of the disclosure are presented for purposes of illustration only. Many variations may be made in the particular arrangements shown. For example, although described in the context of particular system and device configurations, the techniques are applicable to a wide variety of other types of information processing systems, computing systems, data storage systems, processing devices and distributed virtual infrastructure arrangements. In addition, any simplifying assumptions made above in the course of describing the illustrative embodiments should also be viewed as exemplary rather than as requirements or limitations of such embodiments. Numerous other alternative embodiments within the scope of the appended claims will be readily apparent to those skilled in the art.

1. An apparatus comprising:
at least one processing device comprising a processor coupled to a memory;
the at least one processing device being configured:
to maintain, in memory of a storage system, at least a portion of a log-structured merge data structure comprising metadata entries associated with input-output operations of the storage system, the log-structured merge data structure comprising two or more levels, a given one of the two or more levels comprising a plurality of segments each partitioned into two or more subsegments;
to determine, responsive to detecting a merge condition, a merge set comprising two or more of the plurality of segments in the given level of the log-structured merge data structure;
to merge metadata updates from the determined merge set to a core metadata store of the storage system on a per-subsegment basis across the two or more of the plurality of segments in the determined merge set; and
responsive to (i) completing merge of first subsegments of each of the two or more segments in the determined merge set to the core metadata of the storage system and (ii) prior to completing merge of second subsegments of each of the two or more segments in the determined merge set to the core metadata store of the storage system, to remove one or more resources stored in the memory of the storage system which are associated with the first subsegments of each of the two or more segments in the determined merge set.

2. The apparatus of claim 1 wherein the plurality of segments comprise time-ordered metadata entries associated with the input-output operations of the storage system.

3. The apparatus of claim 1 wherein the plurality of segments in the given level of the log-structured merge data structure are partitioned into the two or more subsegments utilizing hash-based partitioning.

4. The apparatus of claim 3 wherein the hash-based partitioning is based at least in part on utilizing a hash function of one or more most significant bits of keys of the metadata entries associated with the input-output operations of the storage system.

5. The apparatus of claim 3 wherein the hash-based partitioning utilizes a hash function that distributes the metadata entries associated with the input-output operations substantially equally among the two or more subsegments.

6. The apparatus of claim 1 wherein each of the two or more subsegments comprises metadata entries associated with a set of sub-trees of a tree structure maintained in the core metadata store.

7. The apparatus of claim 6 wherein the tree structure maintained in the core metadata store comprises a B-tree.

8. The apparatus of claim 1 wherein the determined merge set comprises less than all of the plurality of segments in the given level of the log-structured merge data structure.

9. The apparatus of claim 1 wherein the at least one processing device is further configured to maintain, in the memory of the storage system, a plurality of bloom filters, each of the two or more subsegments of each of the plurality of segments being associated with a subsegment-specific one of the plurality of bloom filters.

10. The apparatus of claim 9 wherein removing the one or more resources stored in the memory of the storage system which are associated with the first subsegments of each of the two or more segments in the determined merge set comprises removing subsegment-specific ones of the plurality of bloom filters associated with the first subsegments of each of the two or more segments in the determined merge set.

11. The apparatus of claim 1 wherein merging the metadata updates from the determined merge set to the core metadata store of the storage system on the per-subsegment basis is performed in a set of cycles, each cycle comprising merging of metadata updates associated with a specific subsegment index associated with one of the two or more subsegments in each of the two or more segments in the merge set.

12. The apparatus of claim 1 wherein removing the one or more resources stored in the memory of the storage system which are associated with the first subsegments of each of the two or more segments in the determined merge set comprises removing the first subsegments of each of the two or more segments in the determined merge set from the memory of the storage system.

13. The apparatus of claim 1 wherein merging the metadata updates from the determined merge set to the core metadata store of the storage system on the per-subsegment basis comprises merging metadata updates from the first subsegments in each of the two or more segments in the determined merge set utilizing a first worker thread that operates at least in part in parallel with merging metadata updates from the second subsegments in each of the two or more segments in the determined merge set utilizing a second worker thread.

14. The apparatus of claim 1 wherein the at least one processing device is further configured:
to receive a query directed to one of the plurality of segments of the given level of the log-structured merge data structure that is partitioned into the two or more subsegments;
to identify a target one of the two or more subsegments for the received query based at least in part on computing a hash of a key in the received query; and
to perform the query against the target one of the two or more subsegments.

15. A computer program product comprising a non-transitory processor-readable storage medium having stored therein program code of one or more software programs, wherein the program code when executed by at least one processing device causes the at least one processing device:
to maintain, in memory of a storage system, at least a portion of a log-structured merge data structure comprising metadata entries associated with input-output operations of the storage system, the log-structured merge data structure comprising two or more levels, a given one of the two or more levels comprising a plurality of segments each partitioned into two or more subsegments;
to determine, responsive to detecting a merge condition, a merge set comprising two or more of the plurality of segments in the given level of the log-structured merge data structure;
to merge metadata updates from the determined merge set to a core metadata store of the storage system on a per-subsegment basis across the two or more of the plurality of segments in the determined merge set; and
responsive to (i) completing merge of first subsegments of each of the two or more segments in the determined merge set to the core metadata of the storage system and (ii) prior to completing merge of second subsegments of each of the two or more segments in the determined merge set to the core metadata store of the storage system, to remove one or more resources stored in the memory of the storage system which are associated with the first subsegments of each of the two or more segments in the determined merge set.

16. The computer program product of claim 15 wherein the program code when executed by the at least one processing device further causes the at least one processing device to maintain, in the memory of the storage system, a plurality of bloom filters, each of the two or more subsegments of each of the plurality of segments being associated with a subsegment-specific one of the plurality of bloom filters.

17. The computer program product of claim 16 wherein removing the one or more resources stored in the memory of the storage system which are associated with the first subsegments of each of the two or more segments in the determined merge set comprises removing subsegment-specific ones of the plurality of bloom filters associated with the first subsegments of each of the two or more segments in the determined merge set.

18. A method comprising:
maintaining, in memory of a storage system, at least a portion of a log-structured merge data structure comprising metadata entries associated with input-output operations of the storage system, the log-structured merge data structure comprising two or more levels, a given one of the two or more levels comprising a plurality of segments each partitioned into two or more subsegments;
determining, responsive to detecting a merge condition, a merge set comprising two or more of the plurality of segments in the given level of the log-structured merge data structure;
merging metadata updates from the determined merge set to a core metadata store of the storage system on a per-subsegment basis across the two or more of the plurality of segments in the determined merge set; and
responsive to (i) completing merge of first subsegments of each of the two or more segments in the determined merge set to the core metadata of the storage system and (ii) prior to completing merge of second subsegments of each of the two or more segments in the determined merge set to the core metadata store of the storage system, removing one or more resources stored in the memory of the storage system which are associated with the first subsegments of each of the two or more segments in the determined merge set;
wherein the method is performed by at least one processing device comprising a processor coupled to a memory.

19. The method of claim 18 further comprising maintaining, in the memory of the storage system, a plurality of bloom filters, each of the two or more subsegments of each of the plurality of segments being associated with a subsegment-specific one of the plurality of bloom filters.

20. The method of claim 19 wherein removing the one or more resources stored in the memory of the storage system which are associated with the first subsegments of each of the two or more segments in the determined merge set comprises removing a subsegment-specific ones of the plurality of bloom filters associated with the first subsegments of each of the two or more segments in the determined merge set.
